(19) United States
(12) Patent Application Publication
(10) Pub. No.: US 2025/0143381 A1
(43) Pub. Date: May 8, 2025

(54) Aerosol Generation System

(71) Applicant: JT INTERNATIONAL SA, Geneva (CH)

(72) Inventors: Layth Sliman Bouchuiguir, Bellevue (CH); Pier Paolo Monticone, Le Grand-Saconnex (CH)

(73) Assignee: JT INTERNATIONAL SA, Geneva (CH)

(21) Appl. No.: 18/837,035

(22) PCT Filed: Feb. 7, 2023
(86) PCT No.: PCT/EP2023/052960

§ 371 Date: Aug. 8, 2024

(30) Foreign Application Priority Data
Feb. 10, 2022 (EP) 22156073.3

(51) Int. Cl. A24F 40/95; A24F 40/20; A24F 40/53; A24F 40/60; H02J 7/00

(52) U.S. Cl. CPC A24F 40/95; A24F 40/53; A24F 40/60; H02J 7/0036; H02J 7/0044; H02J 7/0047; A24F 40/20

(57) ABSTRACT

An aerosol generation system includes an electrical holder configured to generate an aerosol by heating an aerosol generation article, and a charging device including a body having an inner housing into which the electrical holder can be inserted for being recharged. The electrical holder is configured to detect when it is not inserted in the inner housing, and to provide to a user information representative of an absence of the electrical holder in the inner housing in the presence of the detection. The electrical holder is configured to provide the information when it has not been inserted in the inner housing during a chosen duration.

### FIELD OF THE INVENTION

The present invention relates to aerosol generation systems comprising a charging device with an inner housing for receiving an electrical holder to recharge.

### BACKGROUND

Some aerosol generation systems comprise a charging device comprising a body having an inner housing and that may be connected to the mains supply during a recharge phase, and an electrical holder configured to generate an aerosol by heating an aerosol generation article during a vaping session of a user and that can be inserted in the body inner housing for being recharged.

For instance, the electrical holder may be the so-called “T-vapor (or heat-not-burn (or “HnB”)) device” which comprises a heater for heating a “solid” substance of an aerosol generation article (for instance a tobacco stick) inserted into its inner housing (or casing) and similar to a traditional cigarette.

Sometimes the user of an electrical holder forgets to insert the latter into the body inner housing of the associated charging device after his last vaping session. So, when this user wants to start a new vaping session with a new aerosol generation article, the energy level of the electrical holder battery can be found too low to allow this vaping session, and therefore the user must recharge his electrical holder in the associated charging device before starting his vaping session. This delay may cause frustration and disappointment.

Moreover, it happens also that a user believes he has inserted his electrical holder in the associated charging device but there is no way to verify this insertion unless opening the charging device to check if the electrical holder is inside, which may be annoying and time consuming.

Some charging device bodies comprise a lighting element (such as a LED (“Light Emitting Diode”)) that generates a light during a recharge of an electrical holder. But, when the recharge phase is finished the light is no longer generated and therefore the user cannot know if there is an electrical holder inserted in his charging device when he just takes a look at this charging device. So, the user must open the charging device to check if the electrical holder is inside, which may be also annoying and time consuming.

Furthermore, the repetition of openings and closings for checking insertion may impact the durability of the mechanics that drives the door controlling access to the body inner housing.

So, the present invention aims at improving the situation.

### SUMMARY

The proposed invention provides an embodiment of an aerosol generation system comprising an electrical holder configured to generate an aerosol by heating an aerosol generation article, and a charging device comprising a body having an inner housing into which the electrical holder can be inserted for being recharged.

The aerosol generation system is characterized in that said electrical holder is configured to detect when it is not inserted in said inner housing, and to provide to a user information representative of an absence of said electrical holder in said inner housing in the presence of said detection, wherein said electrical holder is configured to provide said information when it has not been inserted in said inner housing during a chosen duration.

Thanks to the invention, a user is reminded to insert their electrical holder into the charging device in the event that it is not being used for vaping, helping to ensure that the electrical holder is charged when the user next requires it.

The electrical holder of the aerosol generation system may comprise other features, considered separately or combined, and notably:
the chosen duration may be a predetermined duration following a last vaping session;
said electrical holder may further includes a heating element and circuitry operable to control the heating element during a vaping session, wherein said circuitry is operable to compare a duration since the last vaping session with the predetermined duration, and to cause the electrical holder to provide the second information if the duration since the last vaping session is equal to or exceeds the predetermined duration;
the second information may be one or more of a light generated by a lighting element, a vibration generated by haptic means, and a message displayed on a user interface.
in a first embodiment the electrical holder may be configured to provide the information during a predetermined time interval;
also in the first embodiment its electrical holder may be configured to detect that it is not inserted in the body inner housing when it is not electrically connected to the charging device inside the inner housing;
also in the first embodiment its electrical holder may comprise a detection circuit configured for generating a detection signal when the electrical holder is not inserted in the inner housing of the charging device, and may be configured for generating the other information when this detection signal is generated;
for instance, the charging device body may comprise a magnet generating a magnetic field, and the detection circuit may comprise a sensor configured for generating the detection signal when it does not detect this generated magnetic field;
in a variant the detection circuit may comprise a motion sensor configured for generating a signal when it does not detect any motion of the electrical holder during a chosen duration;
also in the first embodiment its electrical holder may comprise a rechargeable battery having an energy level, and may be configured to provide the information when this energy level is lower than a predetermined threshold at least equal to an energy level needed for a next vaping session. The electrical holder may be configured to only provide the information when the energy level is lower than a predetermined threshold, even if the chosen duration has elapsed;
in an embodiment its electrical holder may comprise an inner housing arranged for receiving at least a part of an aerosol generation article defining a tobacco stick.

The charging device of the aerosol generation system may comprise other features, considered separately or combined, and notably:
the charging device may be configured for providing another information representative of an absence of the electrical holder in its inner housing on an external surface of its body;
in a first embodiment the charging device body may comprise a window allowing a user to see inside its inner housing. In this embodiment the another information is the empty inner housing when there is no electrical holder inserted in the body inner housing;
in a second embodiment the charging device body may comprise a window, and a detection element having a first state in which a first part of it is visible in this window when there is no electrical holder inserted in its body inner housing and a second state in which a second part of it is moved and visible in this window when the electrical holder is inserted in the body inner housing;
in the first or second embodiment the charging device body may comprise a fixed wall comprising the window. In a variant of embodiment the charging device body may comprise a door controlling access to the inner housing and comprising the window;
in a third embodiment the charging device body may comprise a detection circuit configured for generating a detection signal when the electrical holder is inserted in its inner housing, and a lighting element configured for generating a light visible on its external surface when it receives the detection signal;
in the third embodiment the detection circuit may comprise a sensor configured for generating the detection signal when it detects a magnetic field generated by a magnet of the electrical holder;
in a fourth embodiment it may be configured for generating a detection signal when the electrical holder is not electrically connected to an inner connector accessible in its body inner housing. In this embodiment, its body may comprise a lighting element configured for generating a light visible on its external surface when it receives this detection signal.

Thanks to the invention, the user of an electrical holder can now easily check if the latter is effectively inserted into the associated charging device by just looking if the first information is provided or not on a part of the body external surface, without having to open this charging device, which avoids frustration and disappointment.

### BRIEF DESCRIPTION OF THE FIGURES

The invention and its advantages will be better understood upon reading the following detailed description, which is given solely by way of non-limiting examples and which is made with reference to the appended drawings, in which:

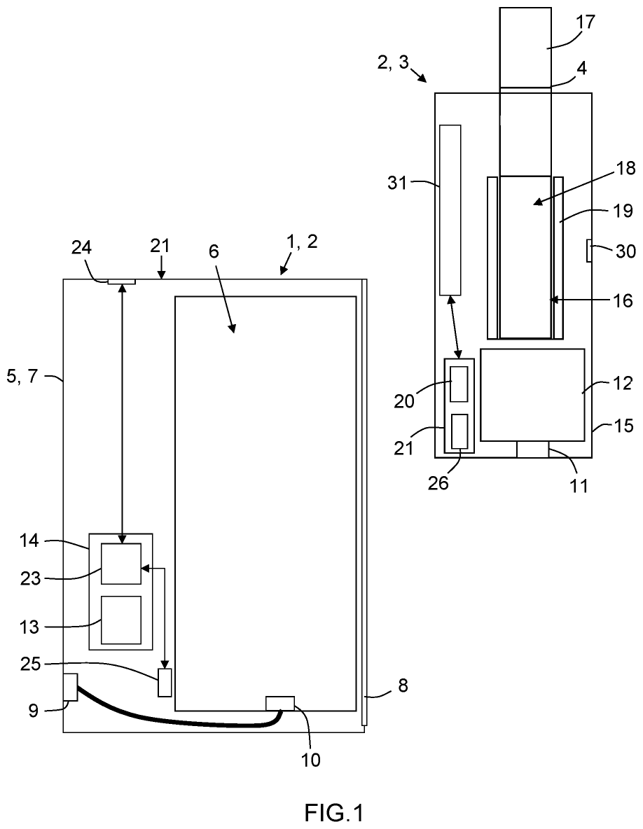

the FIG. 1 schematically and functionally illustrates a first example of embodiment of an aerosol generation system according to the invention, with its electrical holder comprising an aerosol generation article and therefore not inserted into its charging device,

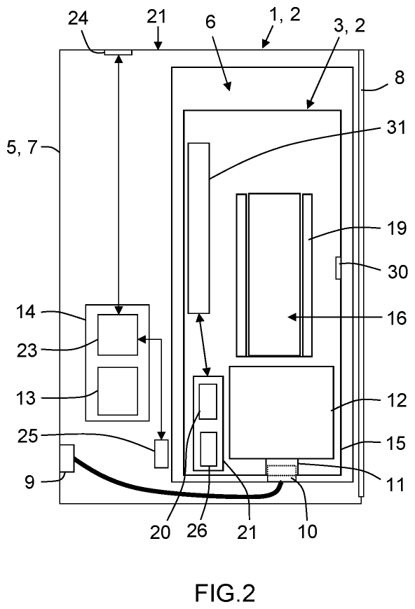

the FIG. 2 schematically and functionally illustrates the aerosol generation system of FIG. 1 after insertion of its electrical holder into its charging device,

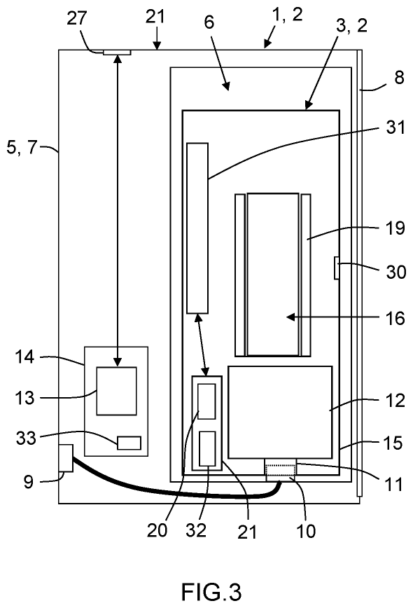

the FIG. 3 schematically and functionally illustrates a second example of embodiment of an aerosol generation system according to the invention, after insertion of its electrical holder into its charging device,

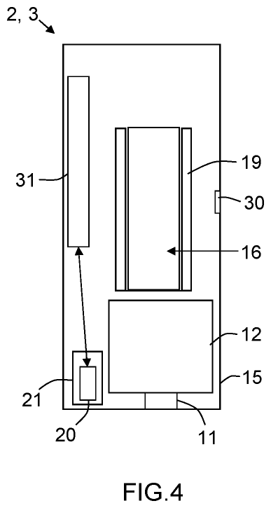

the FIG. 4 schematically and functionally illustrates a variant of embodiment of an electrical holder of an aerosol generation system according to the invention, before insertion in an associated charging device,

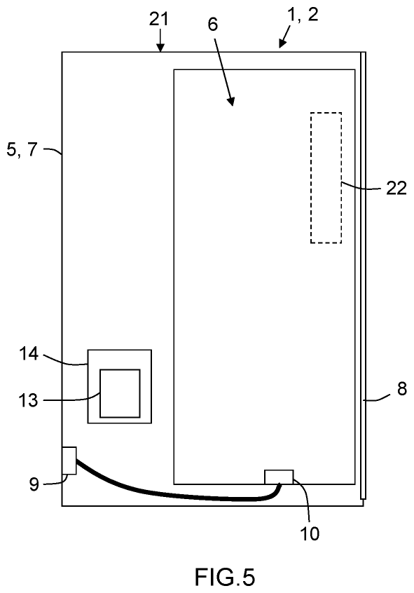

the FIG. 5 schematically and functionally illustrates a variant of embodiment of a charging device according to the invention, and

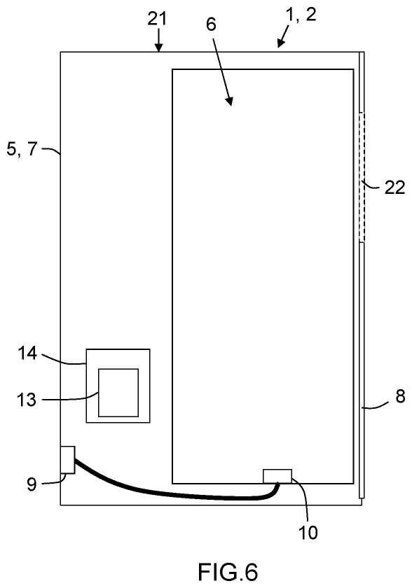

the FIG. 6 schematically and functionally illustrates another variant of embodiment of a charging device according to the invention.

### DETAILED DESCRIPTION OF EMBODIMENTS

The invention aims at offering a charging device 1 intended for being part of an aerosol generation system 2 and for recharging an electrical holder 3 intended for receiving an aerosol generation article 4 and that is another part of this aerosol generation system 2.

In the following description it will be considered that the electrical holder 3 is (or constitutes) a T-vapor (or heat-not-burn (or HnB)) device comprising a heating element (or heater) 19 for heating a solid substance 18 of an aerosol generation article 4. But an electrical holder 3 according to the invention could be of another type, as soon as it allows to transform an aerosol-forming substance in solid form into an aerosol (possibly close to room temperature) by heating.

Moreover, in the following description it will be considered that the aerosol generation article (or consumable) 4 is a tobacco stick. So, the solid substance comprises at least tobacco material (possibly shredded tobacco). But the invention is not limited to this type of aerosol generation article (or consumable).

Here, a “solid substance” designates any solid material that is aerosolizable in air by heating to form an aerosol. So, it may comprise one or more of nicotine, tobacco material, polyol, caffeine or other active components, or else flavoring, for instance.

The term “aerosol” may include a suspension of substance as one or more of solid particles, liquid droplets and gas, and such a suspension may be in a gas including air.

As illustrated in FIGS. 1 and 2 an aerosol generation system 2, according to the invention, comprises a charging device 1 and an electrical holder 3 intended for receiving an aerosol generation article 4 notably when it is not in a recharge phase in this charging device 1.

As illustrated in the non-limiting examples of FIGS. 1 to 3, 5 and 6, a charging device 1, according to the invention, comprises at least a body 5 having an inner housing (or casing) 6 into which an electrical holder 3 can be inserted for being recharged. The body 5 is delimited by walls 7 and also possibly by a door 8 (as illustrated in the non-limiting examples of FIGS. 1 to 3, 5 and 6). The body 5 also comprises a first circuitry 13, a first electrical connector 9 intended for being coupled to a mains supply via a power cable during a recharge phase, and a second electrical connector 10 accessible in its inner housing 6 and to which a third electrical connector 11 of the electrical holder 3 is coupled when the latter (3) is inserted into its inner housing 6 (as illustrated in FIGS. 2 and 3).

The possible door 8 controls access to the inner housing 6, and allows insertion and extraction of the electrical holder 3. For instance, it may be coupled to mechanics (not illustrated) that allow its opening and closing by rotation.

The first circuitry (or processing unit) 13 comprises at least a processor and a memory arranged for performing operations, and notably controlling each recharge phase. For instance, the (each) processor may be a digital signal processor (or DSP), or an application specific integrated circuit (ASIC), or else a field programmable gate array (FPGA). More generally, the processor may comprise integrated (or printed) circuits, or several integrated (or printed) circuits connected therebetween through wired or wireless connections. The term “integrated (or printed) circuits” refers here to any type of device capable of carrying out at least one electric or electronic operation. Also, for instance, the memory may be a random access memory (or RAM). But it may be any type of device arranged for storing program instructions for the associated processor.

Generally speaking, the functions of the first circuitry 13 may be carried out through the operation of program logic, through dedicated logic, through the interaction of program control and dedicated logic, or even partially manually (by a user). These functions may be provided through the use of dedicated hardware as well as hardware capable of executing software in association with appropriate software.

The first circuitry 13 may also comprise, in addition to its processor(s) and memory(ies), an input interface, a mass memory (notably for storing intermediate data produced during its calculus and processing), and an output interface for delivering messages and instructions.

For instance, and as illustrated in the non-limiting examples of FIGS. 1 to 3, 5 and 6, the first circuitry 13 may be fixed onto a printed circuit board (or PCB) 14 (here housed in its body 5).

The electrical holder 3 is configured to generate an aerosol by heating (but not burning) an aerosol generation article 4 (here a tobacco stick) and can be inserted in the body inner housing 6 in order that its battery 12 may be recharged during a recharge phase when its third electrical connector 11 has been coupled to the second electrical connector 10 of the charging device 1.

This electrical holder 3 comprises a body (or external casing) 15 comprising an internal chamber 16 in which an aerosol generation article 4 can be introduced (or inserted). As illustrated in FIG. 1, the aerosol generation article 4 may comprise a filter 17, downstream of its solid substance 18. In the non-limiting example of FIG. 1, the aerosol generation article 4 is partly inserted into the internal chamber 16. But in a variant it could be fully inserted into the internal chamber 16.

The solid substance 18 is heated (without burning) by a heating element (or heater) 19 that is supplied with electrical energy originating from the battery 12. In the non-limiting example illustrated in FIGS. 1 to 4 the heating element 19 surrounds the internal chamber 16, and therefore a part of the aerosol generation article 4 (and more precisely its solid substance 18) to heat the latter (18). For instance, the heating element 19 may be a thin film heater wrapped around the outer surface of the internal chamber 16 to heat its side walls and at least a part of its internal volume (which therefore defines a heating chamber). But in a variant (not illustrated) the heating element 19 could be a coil associated with a susceptor or could be a resistive coil heater. In other variants of embodiment (not illustrated), the heating element 19 could be located inside the aerosol generation article 4 or inside the internal chamber 16.

The electrical energy supplied to the heating element 19 during a vaping session is controlled by a second circuitry 20, that may be fixed onto a printed circuit board (or PCB) 21 (here housed in the body (or external casing) 15).

The second circuitry (or processing unit) 20 comprises at least a processor and a memory arranged for performing operations, notably for controlling the heating element 19 during each vaping session. For instance, the (each) processor may be a digital signal processor (or DSP), or an application specific integrated circuit (ASIC), or else a field programmable gate array (FPGA). More generally, the processor may comprise integrated (or printed) circuits, or several integrated (or printed) circuits connected therebetween through wired or wireless connections. Also, for instance, the memory may be a random access memory (or RAM). But it may be any type of device arranged for storing program instructions for the associated processor.

Generally speaking, the functions of the second circuitry 20 may be carried out through the operation of program logic, through dedicated logic, through the interaction of program control and dedicated logic, or even partially manually (by a user). These functions may be provided through the use of dedicated hardware as well as hardware capable of executing software in association with appropriate software.

The second circuitry 20 may also comprise, in addition to its processor(s) and memory(ies), an input interface, a mass memory (notably for storing intermediate data produced during its calculus and processing), and an output interface for delivering messages and instructions.

According to the invention the charging device 1 is configured for providing a first information representative of the absence of the electrical holder 3 in its body inner housing 6 on an external surface 21 of its body 5.

Thanks to this first information the user of the aerosol generation system 2 can easily check if his electrical holder 3 is effectively inserted into the associated charging device 1 by just looking if the first information is provided or not on a part of the body external surface 21, without having to open (here) the door 8, which avoids frustration and disappointment. So, if this user has forgotten to recharge the battery 12 of his electrical holder 3 he has just to find it and insert it into the associated charging device 1 to trigger the recharge phase.

Moreover, if the user believes he has inserted his electrical holder 3 in the associated charging device 1, he can easily check it by just looking if the first information is provided or not on a part of the body external surface 21, without having to open (here) the door 8, which also avoids disappointment and consuming time.

Furthermore, given that the user no longer needs to open the door 8 to check if his electrical holder 3 is effectively inserted into the associated charging device 1, the repetition of door openings and closings is notably reduced which increases the durability of the mechanics that drives the door 8.

Several embodiments may be envisaged for the charging device 1.

In a first embodiment illustrated in FIGS. 5 and 6, the body 5 may comprise a window 22 allowing the user to see inside this inner housing 6. In this embodiment the first information is the empty inner housing 6 when there is no electrical holder 3 inserted in the inner housing 6. Such a window 22 makes also easier the user's search when he cannot remember where he left his electrical holder 3, because if it is inserted in the charging device 1 he can see it at a glance through the window 22.

For instance, and as illustrated in the non-limiting example of FIG. 5, the body 5 may comprise a fixed wall 7 comprising the window 22. But, in a variant of embodiment illustrated without limitation in FIG. 6, when the body 5 comprises a door 8 (controlling access to its inner housing 6), this door 8 may comprise the window 22.

In a second embodiment (not illustrated), the body 5 may comprise a window and a detection element having a first state in which a first part of it is visible in this window when there is no electrical holder 3 inserted in the body inner housing 6 and a second state in which a second part of it is moved and visible in this window when an electrical holder 3 is inserted in the body inner housing 6. For instance, the detection element may be a spring-loaded arm (or axle) that is translated in the body inner housing 6 during insertion of the electrical holder 3 and which comprises a first part that is visible in the window when it is in its first state and a second part that reaches the window in its second state, and that comes back automatically to its rest (and initial) position when there is no more electrical holder 3 in the charging device 1 (and therefore it is in its first state).

This second part may be colored in green (or red), for instance. Also for instance, the first part may have a color that is different from the one of the second part. So, the first part may be colored in red (or green), for instance. In this embodiment, when the user sees the red (or green) color in the window 22, he knows that his electrical holder 3 is not inserted in the charging device 1, and when the user sees the green (or red) color in the window 22, he knows that his electrical holder 3 is inserted in the charging device 1.

In a third embodiment illustrated in FIGS. 1 and 2, the body 5 may comprise a detection circuit 23 and a lighting element 24. The detection circuit 23 is configured for generating a detection signal when an electrical holder 3 is inserted in its inner housing 6. The lighting element 24 is configured for generating a light visible on the body external surface 21 when it receives this detection signal. So, when the user sees the light generated by the lighting element 24 on the body external surface 21, he knows that his electrical holder 3 is inserted in the charging device 1, and when the user does not see this light on the body external surface 21, he knows that his electrical holder 3 is not inserted in the charging device 1.

In a variant of embodiment the detection circuit 23 could be configured for generating a detection signal when there is no electrical holder 3 inserted in its inner housing 6. In this variant, when the user sees the light generated by the lighting element 24 on the body external surface 21, he knows that his electrical holder 3 is not inserted in the charging device 1, and when the user does not see this light on the body external surface 21, he knows that his electrical holder 3 is inserted in the charging device 1.

For instance, in the third embodiment the lighting element 24 may comprise at least one LED (or “Light Emitting Diode”).

Also for instance, in the third embodiment the detection circuit 23 may comprise a sensor 25 configured for generating the detection signal when it detects a magnetic field generated by a magnet 26 of the electrical holder 3. For instance, this sensor 25 may be a Hall sensor. Also for instance, the magnet 26 may be fixed on the printed circuit board (or PCB) 21 of the electrical holder 3 (as illustrated without limitation), or on the inner or external surface of the external casing (or body) 15 of the electrical holder 3, or else into a wall of the external casing (or body) 15 of the electrical holder 3. In the alternative, the sensor 25 may be configured for generating the detection signal when it does not detect a magnetic field generated by a magnet 26 of the electrical holder 3.

In a fourth embodiment illustrated in FIG. 3, the charging device 1 may be configured for generating a detection signal when the electrical holder 3 is not electrically connected to its inner (second) connector 10 (that is accessible in its body inner housing 6), and the body 5 may comprise a lighting element 27 configured for generating a light visible on its external surface 21 when it receives this detection signal.

So, when the user sees the light generated by the lighting element 27 on the body external surface 21, he knows that his electrical holder 3 is not inserted in the charging device 1, and when the user does not see this light on the body external surface 21, he knows that his electrical holder 3 is inserted in the charging device 1.

In a variant of embodiment the charging device 1 could be configured for generating a detection signal when the electrical holder 3 is electrically connected to its inner (second) connector 10. In this variant when the user sees the light generated by the lighting element 27 on the body external surface 21, he knows that his electrical holder 3 is inserted in the charging device 1, and when the user does not see this light on the body external surface 21, he knows that his electrical holder 3 is not inserted in the charging device 1.

For instance, in the fourth embodiment the first circuitry 13 may be configured for generating the detection signal. But in a variant the body 5 could comprise a dedicated circuit configured for generating the detection signal.

Also for instance, in the fourth embodiment the lighting element 27 may comprise at least one LED (or Light Emitting Diode).

According to the invention, the electrical holder 3 may be also configured to detect when it is not inserted in the body inner housing 6 of its associated charging device 1, and to provide another (second) information in the presence of this detection. This allows drawing the attention of the user to the fact that he should insert his electrical holder 3 into the associated charging device 1 to recharge its battery 12, in the event he had forgotten to do so before, and in order to have his electrical holder 3 ready for a next vaping session.

Any type of second information may be provided. So, it may be a light generated by a lighting element 30, dedicated or not and that may comprise at least one LED (or Light Emitting Diode), as illustrated in FIGS. 1 to 4, and/or a vibration generated by a haptic means equipping the external casing (or body) 15, and/or a message that is displayed on a user interface 31 equipping the external casing (or body) 15, as illustrated in FIGS. 1 to 4, for instance.

Several embodiments may be envisaged for the electrical holder 3.

In a first embodiment, the electrical holder 3 may be configured to provide the second information during a predetermined time interval. This means that the second information is either provided continuously or repeated (for instance periodically) during the predetermined time interval. This allows avoiding a discharge of the battery 12, because providing continuously the second information consumes some electrical energy. For instance, this predetermined time interval may be comprised between one minute and thirty minutes. In the case where the second information is repeated periodically, the period may be comprised between one minute and ten minutes, for instance.

In a second embodiment (not illustrated), compatible with the first embodiment, the electrical holder 3 may be configured to detect that it is not inserted in the body inner housing 6 when it is not electrically connected to the charging device 1 inside this body inner housing 6. It is recalled that this electrical connection is effective when the third electrical connector 11 (of the electrical holder 3) is connected to the second electrical connector 10 (of the charging device 1).

For instance, in this second embodiment the second circuitry 20 may be configured for generating the detection signal. But in a variant the external casing (or body) 15 could comprise a dedicated circuit configured for generating the detection signal.

In a third embodiment illustrated in FIG. 3 and compatible with the first embodiment, the electrical holder 3 may comprise a detection circuit 32 configured for generating a detection signal when it is not inserted in the body inner housing 6, and may be configured for generating the second information when this detection signal is generated.

For instance, in this third embodiment the second circuitry 20 may be configured for generating the detection signal. But in a variant the external casing (or body) 15 could comprise a dedicated circuit configured for generating the detection signal.

Also for instance, in this third embodiment the detection circuit 32 may comprise a sensor configured for generating the detection signal when it does not detect a magnetic field generated by a magnet 33 equipping the body 5 of the charging device 1. This sensor 25 may be a Hall sensor, for instance. Also for instance, the magnet 33 may be fixed on the printed circuit board (or PCB) 14 of the charging device 1 (as illustrated without limitation), or on the inner or external 21 surface of the body 5 of the charging device 1, or else in a wall 7 of the body 5 of the charging device 1.

In a variant of embodiment, the detection circuit 32 may comprise a motion sensor (not illustrated) configured for generating a signal when it does not detect any motion of its electrical holder 3 during a chosen duration. In this variant of embodiment it is considered that if an electrical holder 3 has not been moved during a long time, there is a high probability that it will soon be used by its user for a vaping session and/or that its battery 12 has not been recharged for a long time and therefore needs to be recharged to be ready for the next vaping session.

For instance, this chosen duration may be comprised between five minutes and thirty minutes.

In a fourth embodiment compatible with the first to third embodiments, when the electrical holder 3 comprises a rechargeable battery 12 having an energy level, it may be configured to provide the second information when this energy level is lower than a predetermined threshold at least equal to an energy level needed for a next vaping session. In this fourth embodiment it is considered that it is not worth informing the user of an electrical holder 3 (because this would be energy consuming), when the energy level is greater than the predetermined threshold and therefore will be sufficient for the whole next vaping session.

For instance, in this fourth embodiment the second circuitry 20 may be configured for generating the detection signal. But in a variant the external casing (or body) 15 could comprise a dedicated circuit configured for generating the detection signal.

In a fifth embodiment compatible with the first to third embodiments, the electrical holder 3 may be configured to provide the second information when it has not been inserted in the body inner housing 6 during a chosen duration. In this fifth embodiment it is considered that it is not worth informing the user of an electrical holder 3 (because this would be energy consuming), when it has been recently recharged in the charging device 1 and therefore has probably a battery energy level sufficient for the whole next vaping session.

For instance, in this fifth embodiment the second circuitry 20 may be configured for triggering a timeout having the chosen duration each time its electrical holder 3 is extracted from the charging device 1, and for generating the detection signal when this timeout expires. But in a variant the external casing (or body) 15 could comprise a dedicated circuit configured for triggering this timeout and generating the detection signal when this timeout expires. In a further variant, the chosen duration may be a predetermined duration following a last vaping session. That is, a timeout may be triggered by the termination of a vaping session. The electrical holder (and for example, the second circuitry 20 of the electrical holder) may be operable to compare a duration since the termination of a last vaping session with the predetermined duration, and to cause the electrical holder to provide the second information if the duration since the last vaping session is equal to or exceeds the predetermined duration. The second information may not be provided if the charge level is sufficient for a further vaping session even if the chosen duration has elapsed.

It should be appreciated by those skilled in the art that some block diagrams of FIGS. 1 to 6 herein represent conceptual views of illustrative circuitry embodying the principles of the invention.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. An aerosol generation system comprising an electrical holder configured to generate an aerosol by heating an aerosol generation article, and a charging device comprising a body having an inner housing into which the electrical holder can be inserted for being recharged,
wherein the electrical holder is configured to detect when the electrical holder is not inserted in the inner housing, and to provide to a user second information representative of an absence of the electrical holder in the inner housing in the presence of the detection,
wherein the electrical holder is configured to provide the second information when the electrical holder has not been inserted in the inner housing during a chosen duration.

2. The aerosol generation system according to claim 1, wherein the chosen duration is a predetermined duration following a last vaping session.

3. The aerosol generation system according to claim 2, wherein the electrical holder further includes a heating element and second circuitry operable to control the heating element during a vaping session, wherein the second circuitry is operable to compare a duration since the last vaping session with the predetermined duration, and to cause the electrical holder to provide the second information when a duration since the last vaping session is equal to or exceeds the predetermined duration.

4. The aerosol generation system according to claim 1, wherein the second information is one or more of a light generated by a lighting element, a vibration generated by haptic means, or a message displayed on a user interface.

5. The aerosol generation system according to claim 1, wherein the electrical holder is configured to detect that the electrical holder is not inserted in the inner housing when the electrical holder is not electrically connected to the charging device inside the inner housing.

6. The aerosol generation system according to claim 1, wherein the electrical holder comprises a detection circuit configured for generating a detection signal when the electrical holder is not inserted in the inner housing, and is configured for generating the second information when the detection signal is generated.

7. The aerosol generation system according to claim 6, wherein the body further comprises a magnet generating a magnetic field, and wherein the detection circuit comprises a sensor configured for generating the detection signal when the detection circuit does not detect the generated magnetic field.

8. The aerosol generation system according to claim 1, wherein the electrical holder comprises a rechargeable battery having an energy level, and wherein the electrical holder is configured to provide the second information only when the energy level is lower than a predetermined threshold at least equal to an energy level needed for a next vaping session.

9. The aerosol generation system according to claim 1, wherein the charging device is configured for providing first information representative of an absence of the electrical holder in the inner housing on an external surface of the body of the charging device.

10. The aerosol generation system according to claim 9, wherein the body further comprises a window allowing a user to see inside the inner housing, the first information being the empty inner housing when there is no electrical holder inserted in the inner housing.

11. The aerosol generation system according to claim 9, wherein the body further comprises a window, and a detection element having a first state in which a first part of the detection element is visible in the window when there is no electrical holder inserted in the inner housing and a second state in which a second part of the detection element is moved and visible in the window when the electrical holder is inserted in the inner housing.

12. The aerosol generation system according to claim 10, wherein the body further comprises a fixed wall comprising the window, or a door controlling access to the inner housing and comprising the window.

13. The aerosol generation system according to claim 9, wherein the body further comprises a detection circuit configured for generating a detection signal when the electrical holder is not inserted in the inner housing, and a lighting element configured for generating a light visible on the external surface when the lighting element receives the detection signal.

14. The aerosol generation system according to claim 13, wherein the detection circuit comprises a sensor configured for detecting a magnetic field generated by a magnet of the electrical holder, and for generating the detection signal when the sensor does not detect the generated magnetic field.

15. The aerosol generation system according to claim 9, wherein the charging device is configured for generating a detection signal when the electrical holder is not electrically connected to an inner connector accessible in the inner housing, and wherein the body further comprises a lighting element configured for generating a light visible on the external surface when the lighting element receives the detection signal.
